(19) United States
(12) Patent Application Publication
(10) Pub. No.: US 2010/0235908 A1
(43) Pub. Date: Sep. 16, 2010

(54) System and Method for Detection of a Change in Behavior in the Use of a Website Through Vector Analysis

(75) Inventors: Mike Eynon, Mountain View, CA (US); Laura Mather, Mountain View, CA (US); Erik Westland, Carlisle, MA (US); Jim Lloyd, San Francisco, CA (US)

Correspondence Address: BUCHANAN, INGERSOLL & ROONEY PC, POST OFFICE BOX 1404, ALEXANDRIA, VA, 22313-1404, US

(73) Assignee: Silver Tail Systems, Palo Alto, CA (US)

(21) Appl. No.: 12/404,152

(22) Filed: Mar. 13, 2009

(51) Int. Cl. G06F 21/00

(52) U.S. Cl. 726/22

(57) ABSTRACT

A system and method for identifying the change of user behavior on a website includes analyzing the actions of users on a website comprising a plurality of parameters or parameters that identify the actions performed on a website including parameters or fields related to previous actions by that user or other users of the website. The parameters or fields are represented in a vector format where each vector represents a different session of activity on the website, page of the website, user of the website, or other attribute of the use of a website. Analysis is performed to determine if new sessions are similar or dissimilar to previously known sessions.

### BACKGROUND

1. Field of the Invention

The present invention relates to computer systems and methods for detecting new uses of legitimate business flows of websites. It is important for websites to understand the new ways users are using their sites since this can help identify both new legitimate and malicious uses of a website.

2. Background Information

In 2005, 75% of all fraud perpetrated through the internet was initiated through websites and only 25% of online fraud was initiated through email. Because of the success of technologies like firewalls, intrusion prevention systems, and web application security, bad actors are finding more sophisticated ways to steal money and victimize internet users and the owners of websites.

There are many ways criminals can use websites to victimize users or the owners of the websites. Some of these fraud types include stealing money using stolen passwords, selling merchandise that will not be delivered, paying for merchandise with illicit funds (either stolen funds or through fraudulent payment mechanisms like fake cashier's checks), false offers of money (also known as Nigerian scams), soliciting accomplices to do things like receive illicit funds or illicit goods and pass them along to the scammer, spam users with nuisance messages, deliver email or other messages that contain malicious code, etc.

In the past, many of these fraud types were perpetrated by trying to “break in” to the systems or intranets of the targeted companies. By finding holes in VPNs (Virtual Private Networks), firewalls, or databases, fraudsters could steal money or credentials to perpetrate their fraud. Because intrusion protection products have become much more powerful, fraudsters have had to find other ways to make their profits. The next step in the progression was to find bugs in a website's code and use those bugs to perform the illicit activity. Web application security vendors now check website code to find code vulnerabilities that allow fraudsters access to sensitive information so that these vulnerabilities can be addressed.

Because web application security finds the code vulnerabilities on websites, fraudsters have turned to an even more sophisticated methodology for exploiting websites and the users of those websites. Business logic abuse is defined as the abuse of legitimate pages of a website to perpetrate fraud and other illicit behaviors. A simple example of business logic abuse is guessing passwords to steal accounts on websites. By testing passwords on the signin page of a website, the fraudster is using a legitimate website business flow—the signin function—to perpetrate bad activity. Other examples of malicious use of websites through legitimate business flows include the mass registration of accounts (for example to send spam on social network sites or to game incentive programs on financial institution or e-commerce sites), scraping of email addresses and personal information off of social network sites, scraping of financial and personal information off of financial institution websites.

New website behaviors are not always fraudulent. There are cases where website owners want to change the behaviors of users on their site. An example is a website that launches a new feature—that website wants its users to take advantage of the new feature, thereby changing the way the users use the website. Another example is when a particular feature of a website becomes popular because of news coverage. Website owners want to know when new behaviors are occurring on their websites so they can track adoption of features, understand the usage of their site, or determine fraudulent events on their site.

### SUMMARY OF THE INVENTION

A behavior change detection system is configured to detect changing user behaviors on a website by mapping website session information into numerical vectors and using the vector spaces associated with those vectors to track the changes in website session behaviors. The distance between a vector for a particular session, user, etc. and the exemplar of a normal session, user, etc. are compared to determine how close the actions of the current session, user, etc. is to expected behavior. As the distance from the exemplar vector increases, the likelihood the behavior is a new behavior also increases. As thresholds are met that indicate a session vector deviates enough from the exemplar to indicate new behavior, appropriate actions can be taken to better understand and respond to that behavior.

In one aspect, historical vectors are used to determine the exemplar session vectors for a website. All or a subset of historical vectors can be used.

In another aspect, the distance between a session vector and the exemplar vector is taken into account to determine the likelihood of the current session representing a new behavior for the website.

In accordance with a further aspect, a method for determining a likelihood of a previously unknown use of a website associated with using a computer system that processes data from a website session into a plurality of parameters configured to represent the website session information, and wherein the parameters are combined into a vector in a vector space, the method comprises: mapping the vector into various vector spaces; comparing the vector with other vectors based on the distance between the vector and the other vectors in the various vector spaces; evaluating the vector using a comparison between the other vectors in the same or similar vector spaces; generating a score indicative of the similarity between the vector and the other vectors in the same or similar vector spaces; and returning the score to an investigation system for analysis.

In accordance with another aspect, a method for determining a likelihood of a previously unknown use of a website associated with a website session, comprises: receiving a plurality of parameters associated with an action performed during a website session; creating a session vector that has a dimension corresponding to each of the plurality of parameters associated with the action performed during the website session; creating an exemplar session vector based on other session vectors within a vector space; and comparing the session vector to the exemplar session vector in the various vector spaces.

In accordance with a further aspect, a method of mapping website session data into a vector space comprises: parsing website session data into a plurality of parameters; and mapping the plurality of parameters into n-dimensional vectors, wherein n is a number of parameters available about an action on a website, and wherein each vector is mapped into an n-dimensional space associated with the plurality of parameters related to the action on the website.

In accordance with another aspect, a behavior change detection system comprises: a website data center, which receives a plurality of input parameters associated with website actions; and a behavior change detection center configured to detect behavior changes by users of a website based on: receiving a plurality of input parameters associated with website actions performed during a website session; creating a session vector that has a dimension corresponding to each of the plurality of input parameters associated with the website actions performed during the website session; creating an exemplar session vector based on other session vectors within a vector space; and comparing the session vector to the exemplar session vector in the various vector spaces.

In accordance with a further aspect, a computer readable medium containing a computer program for determining a likelihood of a previously unknown use of a website associated with a website session, wherein the computer program comprises executable instructions for: receiving a plurality of parameters associated with an action performed during a website session; creating a session vector that has a dimension corresponding to each of the plurality of parameters associated with the action performed during the website session; creating a exemplar session vector based on other session vectors within a vector space; and comparing the session vector to a exemplar session vector in the various vector spaces.

These and other features, aspects, and embodiments of the invention are described below in the section entitled “Detailed Description.”

### BRIEF DESCRIPTION OF THE DRAWINGS

For a better understanding of the nature of the features of the invention, reference should be made to the following detailed description taken in conjunction with the accompanying drawings, in which:

FIG. 1 depicts a system for detecting changes to behavior on websites which includes the data center for a website and software for processing the website session data to detect behavior changes;

FIG. 2 depicts a system for detecting changes to behavior on websites which includes a computing environment for a website and software for processing the website session data to detect behavior changes in a cloud computing environment;

FIG. 3 illustratively represents a model data flow representative of the processing of website session data to detect behavior changes on a website as part of the behavior detection system of FIG. 1;

FIG. 4 illustrates a simplified diagram of session data mapped into a vector space, wherein the vector space is represented by two dimensions;

FIG. 5 illustrates a simplified diagram of finding the distance between a vector associated with a particular session with the exemplar vector corresponding to the particular action; and

FIG. 6 illustrates a simplified diagram of using the distance between a vector associated with a particular action on a website and the vector associated with an exemplar session associated with that action to compute a score for whether the particular vector represents a behavior change.

### DETAILED DESCRIPTION OF THE INVENTION

The present invention is directed to a system and method for determining when user behavior on a website changes. In an exemplary embodiment of the invention, website behavior change is detected using feature vectors mapped into vector spaces and compared with other vectors in those spaces to determine anomalous behavior versus typical behavior. Mapping website behavior into vector spaces provides a generalized methodology for building a multi-dimensional representation of user actions on a website. This generalized methodology allows the comparison of the current user, page view, or action on a website with what is known as a exemplar user, page view, or action on a website. By comparing the distance in a vector space between the known typical behavior and the current behavior, decisions can be made as to whether the current behavior deviates in a meaningful way from typical behavior. In the case the current behavior deviates in a meaningful way from typical behavior, alerts can be issued to the appropriate parties. These techniques have proven to be efficient and effective even though the number of possible useful features of given vector spaces will generally be large.

The inventive system operates upon an incoming stream of input data generated by actions on a website. Example actions on a website generally correspond to clicks by the user of the website. These clicks can be done by a human or by an automated computer program. Automated computer programs can work by simulating website clicks or by working through the application programming interface of the website.

Examples of actions taken on websites include clicks to go to other pages of the websites and entering data into forms on the website. Examples of entering data into forms on a website include entering a user name and password on a website to sign-in to the website, filling out an email form to send email to another user of the website, or entering personal information to register for an account on the website.

As described in further detail below, each website action consists of multiple parameters as defined by any information corresponding to the action on the website that can be seen by the processors and computers related to a web server, a firewall, or other device that processes website traffic and additional information provided by the website or third parties. Examples of parameters associated with website actions include IP addresses, including those of any proxies used in the process of sending traffic to the website, browser header information, operating system information, information about other programs installed on the user's machine, information about the clock and other settings on the user's machine, cookies, referring URLs, usernames, parameters associated with a post to the website, and any other information associated with the user's action on the website. Examples of information provided by the website include the length of time the username has been registered, account numbers associated with the username, account balances associated with the username, previous actions performed by the cookie, etc. Examples of data provided by third parties include fraud probabilities associated with internet protocol addresses, geo-location information associated with internet protocol addresses, frequency scores associated with passwords, etc. Any other information that can be seen by the web server, firewall, etc. can be used in this model to map the current action into the vector space.

As each new action on the website occurs, the parameters associated with that action are mapped into several vector spaces. Examples of typical vector spaces include a vector space associated with a user, a vector space associated with a particular page, a vector space associated with a particular referring URL, etc.

Mapping the parameters associated with an action on a website into vector form means creating a vector that has a dimension corresponding to each of the parameters associated with an action on the website. As an action is processed, the web server, firewall, or other transaction processing device receives the information about the action on the website. The inventive system takes the information associated with the action on the website, parses out the specific data associated with each parameter of the action, creates a numerical representative of that data element, and puts that representative of the data element into its corresponding position in the associated vector. The representatives of the data elements are numerical values. In the case a parameter associated with an action is not a numerical value, that parameter is mapped to a numerical value using a hash function or lookup table.

As new actions are fed into the system, the vectors corresponding to those actions are updated with the new parameters associated with that action. For example, when looking at a particular website user, as specified by a userID, cookie, or other values, a sequence of actions on a website are called a user's session. In accordance with an exemplary embodiment, the present invention looks at all of the actions in a particular session to determine if the current session is similar or different to the other sessions on the website, other sessions that use a particular website page, etc. In real-time, or in a batch processing mode that operates on timed increments, for example once an hour, the vectors for each action are computed. In addition, an exemplar vector for users, each page on the website, each referring URL, etc. are created. This exemplar vector could be made up of the average actions by a user or for a page or could be derived using other methodologies to determine an exemplar vector. This exemplar vector may take into account all users, actions, pages, etc. or may only consider a subset of those entities.

To determine new website behavior, a score is computed by comparing the distance between each individual vector and the exemplar vector in the corresponding vector space. If the generated score indicates the individual vector deviates from the exemplar vector in a meaningful way, the appropriate action is taken. Some appropriate actions to take include sending alerts to various website fraud detection systems, sending emails to interested parties, etc.

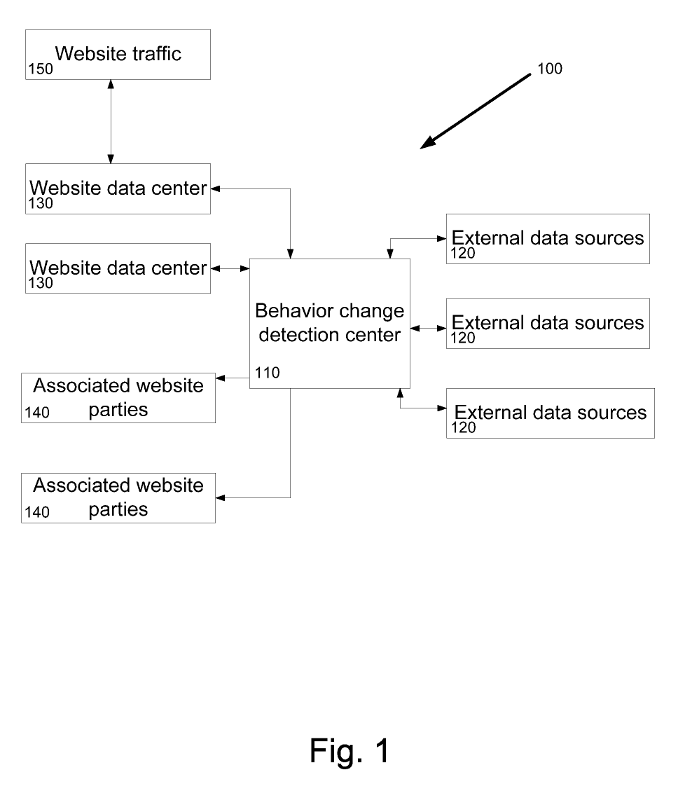

Turning now to FIG. 1, in accordance with an exemplary embodiment, a behavior change detection system 100 includes a behavior change detection center 110 configured to detect behavior changes by the users of a website in accordance with the present invention. The behavior change detection center 110 may utilize data about the actions on a website provided by various external data sources 120 as well as data provided by the website's data center 130 which receives website traffic 150 of the type described below in connection with processing input parameters associated with website actions. In this embodiment of the invention, the website's data center 130 provides the information associated with the action performed on the website. As mentioned above, a notification is provided to the appropriate parties including those at the website's data center 130 or other associated website parties 140 in response to any detected behavior change. In exemplary embodiments the behavior change detection center 110 is capable of determining whether or not a website action constitutes a behavior change on a website in substantially real-time.

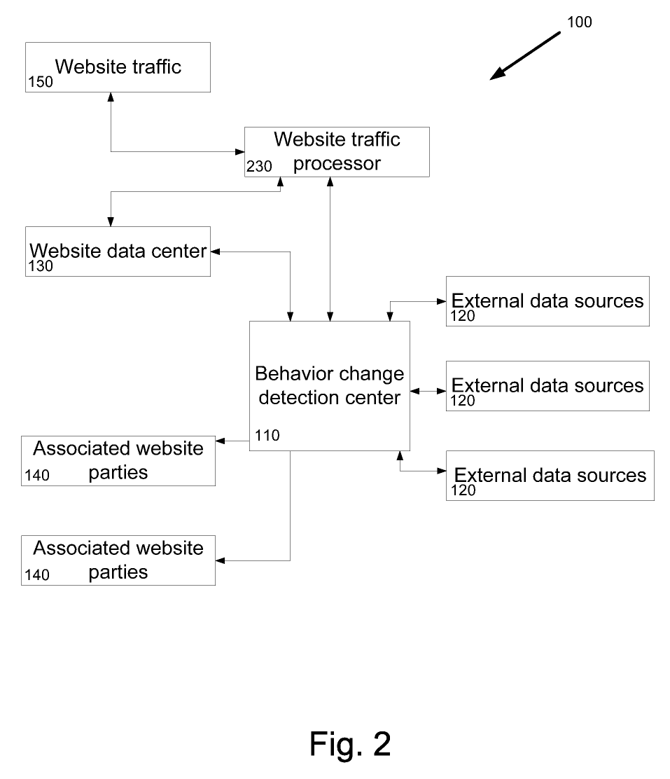

Referring to FIG. 2, a behavior change detection system 100 includes a behavior change detection center 110 configured to detect behavior changes by the users of a website in accordance with the present invention. The behavior change detection center 110 may utilize data about the actions on a website provided by various external data sources 120, data from the website's data center 130, and website traffic processor outside of the website's data center 230 of the type described below in connection with processing input parameters associated with website actions. In this embodiment of the invention, website traffic processor outside of the website's data center 230 provides the information associated with the action performed on the website. As mentioned above, a notification is provided to the appropriate parties including those at the website's data center 130 or other associated website parties 140 in response to any detected behavior change. In exemplary embodiments the behavior change detection center 110 is capable of determining whether or not a website action constitutes a behavior change on a website in substantially real-time.

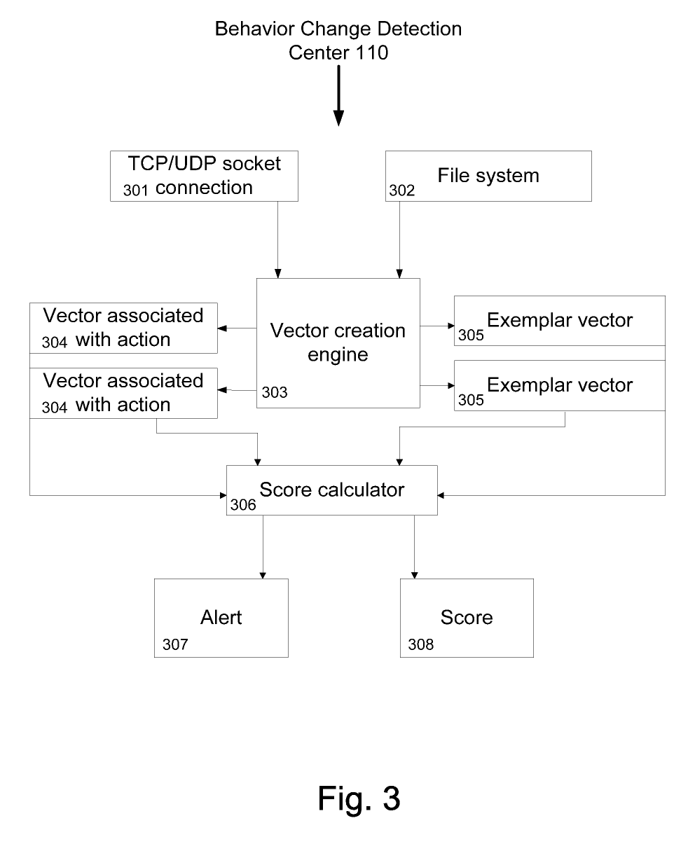

Turning now to FIG. 3, a high-level representation is provided of the behavior change detection center 110. As shown, the behavior change detection center 110 includes a TCP/UDP socket connection 301. The TCP/UDP socket connection 301 accepts data about each individual website action. If external data sources 120 are used, that data is received into the behavior change detection center via the file system 302. The TCP/UDP connection and the file system feed their data into a vector creation engine 303. The vector creation engine 303 transforms the data into associated vectors 304. These associated vectors 304 are input into a score calculator 306, which compares the vectors with exemplar vectors 305 and computes the associated new exemplar vectors 305. In the case a score indicates an action deviates from typical website behavior, an alert 307 is generated that contains the corresponding score 308.

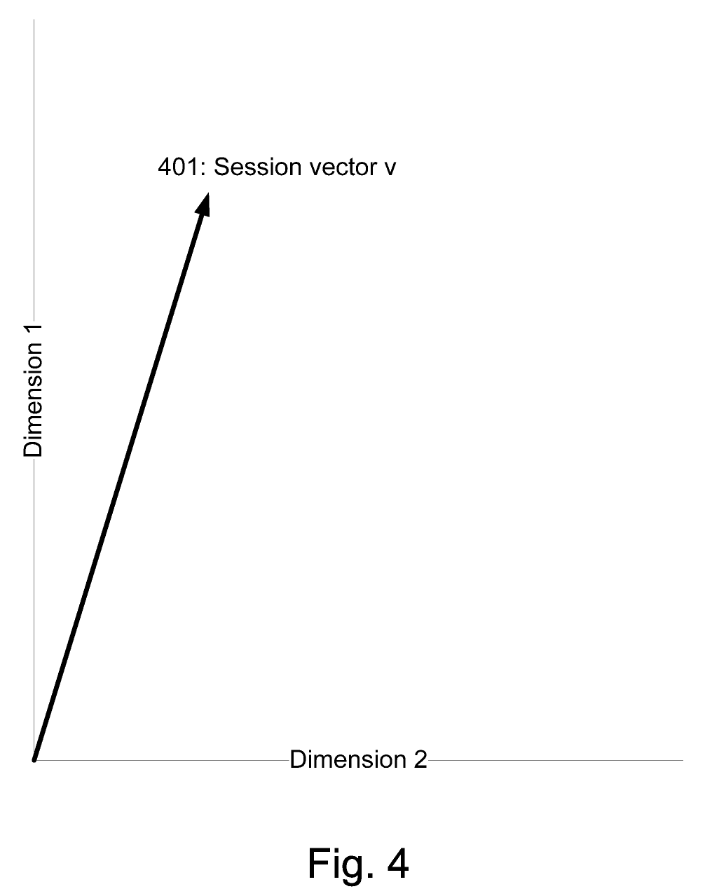

FIG. 4 shows a simplified version of mapping website session data into a vector space. The session data is parsed into multiple parameters. The parameters are mapped into n-dimensional vectors where n is the number of parameters available about the action on the website. Each vector is mapped into the n-dimensional space associated with the dimensions of the actions on the website. Non-numeric parameters are mapped to numeric values via a lookup table. For purposes of illustration, the diagram in FIG. 4 shows an n-dimensional vector v mapped into a two dimensional vector space 401.

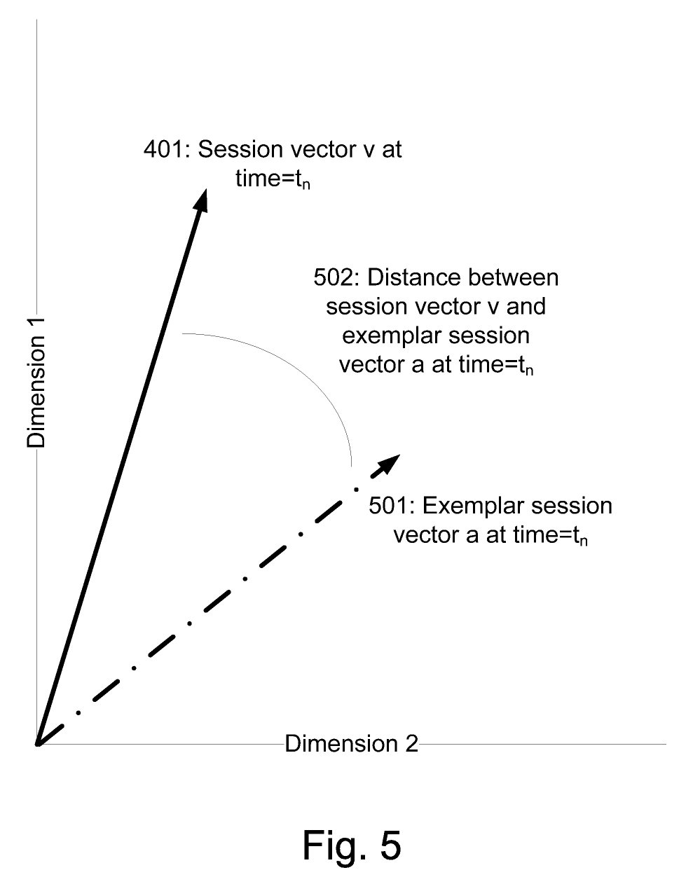

Moving on to FIG. 5, this figure illustrates the distance between a particular session vector v 401 and the exemplar vector for a similar session 501. Again, in this figure, the vectors are shown in two dimensions. It can be appreciated that actual vectors spaces for this dimension consist of hundreds of dimensions.

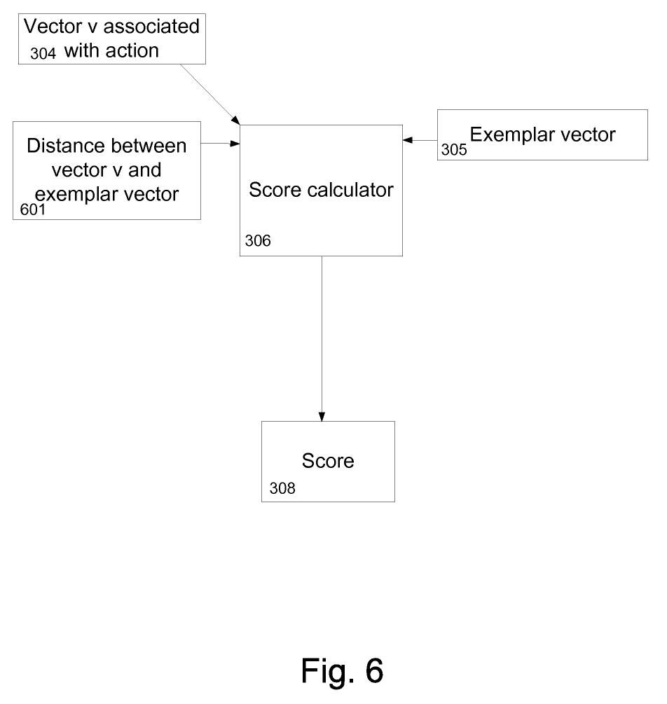

FIG. 6 gives details on a score calculator 306. The score calculator 306 takes as input the current vector v associated with an action 304 and the distance between v and the exemplar vector a 601. These values are combined to create a score 308 that determines the likelihood that the current session is a previously unknown behavior.

In an exemplary embodiment, a computer program which implements all or parts of the processing described herein through the use of a system and/or methodology as illustrated in FIGS. 1-6 can take the form of a computer program product residing on a computer usable or computer readable medium. Such a computer program can be an entire application to perform all of the tasks necessary to carry out the processes and/or methodologies, or it can be a macro or plug-in which works with an existing general-purpose application such as a spreadsheet program. Note that the “medium” may also be a stream of information being retrieved when a processing platform or execution system downloads the computer program instructions through the Internet or any other type of network. Computer program instructions, which implement the invention, can reside on or in any medium that can contain, store, communicate, propagate or transport the program for use by or in connection with any instruction execution system, apparatus, or device. Such a medium may be, for example, but is not limited to, an electronic, magnetic, optical, electromagnetic, or semiconductor system, apparatus, device, or network. Note that the computer usable or computer readable medium could even be paper or another suitable medium upon which the program is printed, as the program can then be electronically captured from the paper and then compiled, interpreted, or otherwise processed in a suitable manner.

It will be understood that the foregoing description is of the preferred embodiments, and is, therefore, merely representative of the article and methods of manufacturing the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed is:

1. A method for determining a likelihood of a previously unknown use of a website associated with using a computer system that processes data from a website session into a plurality of parameters configured to represent the website session information, and wherein the parameters are combined into a vector in a vector space, the method comprising:
mapping the vector into various vector spaces;
comparing the vector with other vectors based on the distance between the vector and the other vectors in the various vector spaces;
evaluating the vector using a comparison between the other vectors in the same or similar vector spaces;
generating a score indicative of the similarity between the vector and the other vectors in the same or similar vector spaces; and
returning the score to an investigation system for analysis.

2. The method of claim 1, wherein the investigation system for analysis is human analysis of the score.

3. A method for determining a likelihood of a previously unknown use of a website associated with a website session, comprising:
receiving a plurality of parameters associated with an action performed during a website session;
creating a session vector that has a dimension corresponding to each of the plurality of parameters associated with the action performed during the website session;
creating an exemplar session vector based on other session vectors within a vector space; and
comparing the session vector to the exemplar session vector in the various vector spaces.

4. The method of claim 3, wherein the exemplar session vector is based on all of the session vectors within a particular vector space.

5. The method of claim 3, further comprising generating a score indicative of a similarity between the session vector and the exemplar session vector in a same or a similar vector space by calculating a distance between the session vector and the exemplar session vector.

6. The method of claim 5, further comprising returning the score to an investigation system for analysis.

7. The method of claim 3, further comprising taking action upon detecting that the session vector has deviated from an expected threshold to indicate a new behavior.

8. The method of claim 3, further comprising using historical vectors to determine the exemplar session vector for the website session.

9. The method of claim 3, wherein each new action on the website generates a new session vector, which is mapped into at least one vector space.

10. The method of claim 3, further comprising combining a plurality of session vectors into a single vector space and analyzing the plurality of vectors as a group.

11. The method of claim 3, wherein the plurality of parameters corresponds to various attributes of the website session.

12. A method of mapping website session data into a vector space comprising:
parsing website session data into a plurality of parameters; and
mapping the plurality of parameters into n-dimensional vectors, wherein n is a number of parameters available about an action on a website, and wherein each vector is mapped into an n-dimensional space associated with the plurality of parameters related to the action on the website.

13. The method of claim 12, further comprising mapping non-numeric parameters to numeric values via a lookup table for use in creating the dimensions of the vector.

14. The method of claim 12, further comprising:
calculating a distance between a particular session vector within the n-dimensional vectors and an exemplar vector for a similar session; and
generating a score that determines a likelihood that a particular session is a previously unknown behavior based on the distance between the particular session vector and the exemplar vector for the similar session.

15. A behavior change detection system comprising;
a website data center, which receives a plurality of input parameters associated with website actions; and
a behavior change detection center configured to detect behavior changes by users of a website based on:
receiving a plurality of input parameters associated with website actions performed during a website session;
creating a session vector that has a dimension corresponding to each of the plurality of input parameters associated with the website actions performed during the website session;
creating an exemplar session vector based on other session vectors within a vector space; and
comparing the session vector to the exemplar session vector in the various vector spaces.

16. The system of claim 15, wherein the website data center provides notification in response to any detected behavior changes.

17. The system of claim 15, wherein the behavior change detection center determines whether or not a website action constitutes a behavior change on a website in substantially real-time.

18. The system of claim 15, further comprising a vector creation engine, which transforms the plurality of input parameters associated with website actions performed during the website session data into session vectors.

19. The system of claim 18, wherein the session vectors and the plurality of input parameters are fed into a score calculator, which compares the session vectors with the exemplar vectors, and upon the score calculator indicating that an action deviates from expected website behavior, an alert is generated that contains a corresponding score.

20. A computer readable medium containing a computer program for determining a likelihood of a previously unknown use of a website associated with a website session, wherein the computer program comprises executable instructions for:
receiving a plurality of parameters associated with an action performed during a website session;
creating a session vector that has a dimension corresponding to each of the plurality of parameters associated with the action performed during the website session;
creating an exemplar session vector based on other session vectors within a vector space; and
comparing the session vector to a exemplar session vector in the various vector spaces.
